(19) United States
(12) Patent Application Publication
(10) Pub. No.: US 2022/0107398 A1
(43) Pub. Date: Apr. 7, 2022

(54) METHOD FOR CONTROLLING WORKING FREQUENCY OF TOF SENSOR, AND APPARATUS, DEVICE, AND MEDIUM

(71) Applicants: BEIJING KUANGSHI TECHNOLOGY CO., LTD., Beijing (CN); MEGVII (BEIJING) TECHNOLOGY CO., LTD., Beijing (CN)

(72) Inventor: Shengyang LIAO, Beijing (CN)

(21) Appl. No.: 17/424,427

(22) PCT Filed: Aug. 20, 2019
(86) PCT No.: PCT/CN2019/101624

§ 371 Date: Jul. 20, 2021

(30) Foreign Application Priority Data
Apr. 18, 2019 (CN) 201910313354.4

(51) Int. Cl. G01S 7/4861; G06V 40/16; G06T 7/521; G06T 7/73; G06T 7/55; G01S 7/48; G01S 17/89; G06Q 20/40

(52) U.S. Cl. CPC G01S 7/4861; G06V 40/161; G06V 40/168; G06T 7/521; G06T 7/73; G06T 2207/30201; G01S 7/4802; G01S 17/89; G06Q 20/40145; G06T 2207/10028; G06T 7/55

(57) ABSTRACT

Embodiments of the present disclosure provide a method for controlling a working frequency of a TOF sensor, an apparatus, a device, and a computer-readable storage medium, and the method includes: inputting a target image frame into a preset face detection model for face detection to determine a face region in the target image frame; determining feature information of the face region, according to the face region and depth information of the target image frame acquired by the TOF sensor; and regulating and controlling the working frequency of the TOF sensor, according to the feature information and a preset working frequency of the TOF sensor. The method achieves dynamic regulation and control of the working frequency of the TOF sensor, and significantly improves the user experience.

The present disclosure claims priority of Chinese Patent Application No. 201910313354.4 filed on Apr. 18, 2019, and the entire content disclosed by the Chinese patent application is incorporated herein by reference as part of the present disclosure.

### TECHNICAL FIELD

The present disclosure relates to a field of computer technology, and in particular, the present disclosure relates to a method for controlling a working frequency of a TOF sensor, an apparatus, a device, and a computer-readable storage medium.

### BACKGROUND

With the development of science and technology and the improvement of application level of technology industrialization, the performance of mobile phones is getting better and better, and the hardware configuration of the mobile phones has become more and more complete. But at the same time, with the increasingly fierce competition in the mobile phone market, hardware configuration can no longer attract more electronic consumers. Therefore, most mobile phone manufacturers are pursuing differentiated functional planning, design, and marketing of mobile phone products. For example, the mobile phone technology applications that are gradually becoming popular include face unlocking, face reshaping, 3D beauty, 3D lighting, and so on.

For an application scenario of controlling the frequency of a TOF (Time of flight) sensor in a payment scenario, the existing technology has the problems that the working frequency (acquisition frequency) of the TOF sensor cannot be adjusted or cannot be adjusted according to application scenarios (such as the payment scenario), and the user experience is poor.

### SUMMARY

Aiming at the defects of the existing technology, the present disclosure provides a method for controlling a working frequency of a TOF sensor, an apparatus, a device, and a computer-readable storage medium, so as to solve the problem of how to dynamically adjust and control the working frequency of the TOF sensor.

In a first aspect, some embodiments of the present disclosure provide a method for controlling a working frequency of a time of flight (TOF) sensor, comprising: inputting a target image frame into a preset face detection model for face detection to determine a face region in the target image frame; determining feature information of the face region, according to the face region and depth information of the target image frame acquired by the TOF sensor; and regulating and controlling a working frequency of the TOF sensor, according to the feature information and a preset working frequency of the TOF sensor.

Optionally, the determining the feature information of the face region, according to the face region and the depth information of the target image frame acquired by the TOF sensor comprises: determining local depth information corresponding to respective parts of the face region, according to the face region and the depth information of the target image frame acquired by the TOF sensor; determining an average depth value of the face region, according to the face region and the local depth information, where the feature information comprises the average depth value.

Optionally, the determining the feature information of the face region, according to the face region and the depth information of the target image frame acquired by the TOF sensor further comprises: determining a deviation ratio between a center point of the face region and a center point of the target image frame, according to the target image frame and the face region, where the feature information further comprises the deviation ratio.

Optionally, before the inputting the target image frame into the preset face detection model for face detection, the method further comprises: acquiring a plurality of image frames to be processed, and acquiring and determining depth information of the plurality of image frames to be processed through the TOF sensor; and the inputting the target image frame into the preset face detection model for face detection to determine the face region in the target image frame, comprises: inputting any image frame to be processed among the plurality of image frames to be processed into the preset face detection model for face detection, and if a face is detected, taking the any image frame to be processed as the target image frame, and determining the face region in the target image frame.

Optionally, the determining the local depth information corresponding to respective parts of the face region, according to the face region and the depth information of the target image frame acquired by the TOF sensor, comprises: determining the local depth information corresponding to respective parts of the face region, according to a feature parameter of the face region and the depth information of the target image frame.

Optionally, the determining the deviation ratio between the center point of the face region and the center point of the target image frame, according to the target image frame and the face region, comprises: determining the deviation ratio, according to a feature parameter of the face region and a feature parameter of the target image frame.

Optionally, the feature parameter of the face region comprises a first start value of the face region corresponding to a first direction, a second start value of the face region corresponding to a second direction, a first width parameter of the face region corresponding to the first direction, a first height parameter of the face region corresponding to the second direction; or, the feature parameter of the face region comprises a first start value and a first end value of the face region corresponding to a first direction, and a second start value and a second end value of the face region corresponding to a second direction; the feature parameter of the target image frame comprises a third start value of the target image frame corresponding to the first direction, a fourth start value of the target image frame corresponding to the second direction, a second width parameter of the target image frame corresponding to the first direction, a second height parameter of the target image frame corresponding to the second direction; or, the feature parameter of the target image frame comprises a third start value and a third end value of the target image frame corresponding to the first direction, and a fourth start value and a fourth end value of the target image frame corresponding to the second direction; where the face region is in a face region plane coordinate system, the first direction of the face region is parallel to a horizontal axis direction of the face region plane coordinate system, and the second direction of the face region is parallel to a longitudinal axis direction of the face region plane coordinate system.

Optionally, the determining the average depth value of the face region, according to the face region and the local depth information, comprises: summing the local depth information to determine a first parameter; determining a second parameter, according to a product of the first width parameter of the face region and the first height parameter of the face region, or determining a second parameter, according to a product of an absolute value of a difference between the first end value and the first start value and an absolute value of a difference between the second end value and the second start value; and dividing the first parameter by the second parameter to determine the average depth value.

Optionally, the regulating and controlling the working frequency of the TOF sensor, according to the feature information and the preset working frequency of the TOF sensor, comprises: regulating and controlling the working frequency of the TOF sensor, according to the average depth value and the preset working frequency of the TOF sensor.

Optionally, the regulating and controlling the working frequency of the TOF sensor, according to the average depth value and the preset working frequency of the TOF sensor, comprises: determining a third parameter, according to a product of the average depth value and the preset working frequency of the TOF sensor; summing the first width parameter of the face region and the first height parameter of the face region to determine a fourth parameter, or summing an absolute value of a difference between the first end value and the first start value and an absolute value of a difference between the second end value and the second start value to determine a fourth parameter; and dividing the third parameter by the fourth parameter to determine an updated working frequency of the TOF sensor, where the updated working frequency is less than an upper threshold of the working frequency.

Optionally, the determining the deviation ratio, according to the feature parameter of the face region and the feature parameter of the target image frame, comprises: determining a first center point parameter of the center point of the face region, according to the first width parameter and the first start value, or determining a first center point parameter of the center point of the face region, according to the first end value and the first start value; determining a second center point parameter of the center point of the face region, according to the first height parameter and the second start value, or determining a second center point parameter of the center point of the face region, according to the second end value and the second start value; determining a third center point parameter of the center point of the target image frame, according to the second width parameter and the third start value, or determining a third center point parameter of the center point of the target image frame, according to the third end value and the third start value; determining a fourth center point parameter of the center point of the target image frame, according to the second height parameter and the fourth start value, or determining a fourth center point parameter of the center point of the target image frame, according to the fourth end value and the fourth start value; determining a fifth parameter, according to the first center point parameter, the third center point parameter, the second center point parameter, and the fourth center point parameter, where the fifth parameter represents a distance between the center point of the face region and the center point of the target image frame; determining a sixth parameter, according to the second width parameter and the second height parameter, or determining a sixth parameter, according to the third end value, the third start value, the fourth end value, and the fourth start value, where the sixth parameter represents half of a diagonal length of the target image frame; and dividing the fifth parameter by the sixth parameter to determine the deviation ratio.

Optionally, the regulating and controlling the working frequency of the TOF sensor, according to the feature information and the preset working frequency of the TOF sensor, comprises: regulating and controlling the working frequency of the TOF sensor, according to the average depth value, the deviation ratio, and the preset working frequency of the TOF sensor.

Optionally, the regulating and controlling the working frequency of the TOF sensor, according to the average depth value, the deviation ratio, and the preset working frequency of the TOF sensor, comprises: determining a third parameter, according to a product of the average depth value and the preset working frequency; summing the first width parameter of the face region and the first height parameter of the face region to determine a fourth parameter, or summing an absolute value of a difference between the first end value and the first start value and an absolute value of a difference between the second end value and the second start value to determine a fourth parameter; determining a seventh parameter, according to a product of the deviation ratio and the preset working frequency; dividing the third parameter by the fourth parameter to determine an eighth parameter; and slimming the seventh parameter and the eighth parameter to determine an updated working frequency of the TOF sensor, where the updated working frequency is less than an upper threshold of the working frequency of the TOF sensor.

Optionally, before the determining the feature information of the face region, according to the face region and the depth information, which is acquired, of the target image frame, the method further comprises: judging whether a preset application is a payment type application according to an identity of the preset application, where the preset application is configured to control an image acquisition device to acquire the target image frame; where the preset application is a payment type application, performing a step of determining the feature information of the face region, according to the face region and the depth information, which is acquired, of the target image frame, and where the preset application is not a payment type application, not regulating and controlling the working frequency of the TOF sensor.

In a second aspect, some embodiments of the present disclosure also provide a control apparatus for controlling a working frequency of a TOF sensor, comprising: a first processing module, configured for inputting a target image frame into a preset face detection model for face detection to determine a face region in the target image frame; a second processing module, configured for determining feature information of the face region, according to the face region and depth information of the target image frame acquired by the TOF sensor; and a third processing module, configured for regulating and controlling a working frequency of the TOF sensor, according to the feature information and a preset working frequency of the TOF sensor.

Optionally, the feature information comprises an average depth value of the face region, the second processing module is configured for determining local depth information corresponding to respective parts of the face region, according to the face region and the depth information of the target image frame acquired by the TOF sensor; and determining the average depth value, according to the face region and the local depth information; the third processing module is configured for regulating and controlling the working frequency of the TOF sensor, according to the average depth value and the preset working frequency of the TOF sensor.

Optionally, the feature information comprises an average depth value of the face region, and a deviation ratio between a center point of the face region and a center point of the target image frame, the second processing module is configured for determining local depth information corresponding to respective parts of the face region, according to the face region and the depth information of the target image frame acquired by the TOF sensor; determining the average depth value, according to the face region and the local depth information; and determining the deviation ratio, according to the target image frame and the face region; the third processing module is configured for regulating and controlling the working frequency of the TOF sensor, according to the deviation ratio, the average depth value, and the preset working frequency of the TOF sensor.

In a third aspect, some embodiments of the present disclosure also provide an electronic device, comprising: a processor, a storage, and a bus; the bus is configured for connecting the processor and the storage, the storage is configured for storing computer programs; and the processor is configured for performing the method for controlling the working frequency of the TOF sensor provided by any one of the above-mentioned embodiments of the present disclosure by calling and running the computer programs.

In a fourth aspect, some embodiments of the present disclosure also provide a computer-readable storage medium, the computer-readable storage medium stores computer programs, when the computer programs are configured for executing the method for controlling the working frequency of the TOF sensor provided by any one of the above-mentioned embodiments of the present disclosure.

The technical solutions provided by the embodiments of the present disclosure have at least the following beneficial effects:

the method for controlling a working frequency of a TOF sensor provided by some embodiments of the present disclosure comprises: inputting a target image frame into a preset face detection model for face detection to determine a face region in the target image frame; determining feature information of the face region, according to the face region and depth information of the target image frame acquired by the TOF sensor; and regulating and controlling a working frequency of the TOF sensor, according to the feature information and a preset working frequency of the TOF sensor, thus achieving dynamic regulation and control of the working frequency of the TOF sensor, according to the distance between the TOF sensor and the face region or according to the distance between the TOF sensor and the face region and the degree (i.e., the deviation ratio) to which the center point of the face region deviates from the center point of the target image frame. If the distance between the TOF sensor and the face region is farther, or if the distance between the TOF sensor and the face region is farther and the deviation ratio is larger, the working frequency of the TOF sensor is increased in real time, thus improving the security of payment; if the distance between the TOF sensor and the face region is closer, or if the distance between the TOF sensor and the face region is closer and the deviation ratio is smaller, the working frequency of the TOF sensor is reduced in real time, thus saving power and reducing power consumption, which significantly improve user experience.

The additional aspects and advantages of the present disclosure will be partly given in the following description, will become obvious from the following description, or will be understood through the practice of the present disclosure.

### BRIEF DESCRIPTION OF THE DRAWINGS

In order to more clearly illustrate the technical solutions in the embodiments of the present disclosure, the drawings required for describing the embodiments of the present disclosure will be briefly described in the following.

FIG. 1A illustrates a schematic flowchart of a method for controlling a working frequency of a TOF sensor according to an embodiment of the present disclosure;

FIG. 1B illustrates a schematic flowchart of another method for controlling the working frequency of the TOF sensor according to an embodiment of the present disclosure;

FIG. 1C illustrates a schematic flowchart of still another method for controlling the working frequency of the TOF sensor according to an embodiment of the present disclosure;

FIG. 2 illustrates a schematic flowchart of another method for controlling the working frequency of the TOF sensor according to an embodiment of the present disclosure;

FIG. 3 illustrates a schematic diagram of a depth image acquired by the TOF sensor according to an embodiment of the present disclosure;

FIG. 4 illustrates a schematic diagram of a frequency curve of a TOF sensor corresponding to a non-payment application according to an embodiment of the present disclosure;

FIG. 5 illustrates a schematic diagram of a frequency curve of a TOF sensor corresponding to a payment application according to an embodiment of the present disclosure;

FIG. 6 illustrates a structural schematic diagram of a control apparatus for controlling the working frequency of the TOF sensor according to an embodiment of the present disclosure; and

FIG. 7 illustrates a structural schematic diagram of an electrical device according to an embodiment of the present disclosure.

### DETAILED DESCRIPTION

The embodiments of the present disclosure are described in detail below, and the examples of the embodiments are illustrated in the drawings, from first to last, the same or similar reference numerals indicate the same or similar elements or elements having the same or similar functions. The embodiments described below with reference to the accompanying drawings are exemplary, are only intended to illustrate the present disclosure, and cannot be construed as limiting the present disclosure.

Those skilled in the art can understand that, unless specifically stated otherwise, the singular forms “a”, “an”, “the” and “said” used herein may also include plural forms. It should be further understood that the word “comprise” used in the specification of the present disclosure refers to the presence of the described features, integers, steps, operations, elements, and/or components, but does not exclude the presence or addition of one or more other features, integers, steps, operations, elements, components, and/or combinations thereof. It should be understood that when describing that an element is “connected” or “coupled” to another element, it means that the element can be directly connected or coupled to another element, or an element can be disposed therebetween. In addition, “connected” or “coupled” used herein may include wireless connection or wireless coupling. The term “and/or” used herein includes all or any unit and all combinations of one or more associated listed items.

Those skilled in the art can understand that, unless otherwise defined, all terms (including technical terms and scientific terms) used herein have the same meaning as commonly understood by those of ordinary skill in the art to which the present disclosure belongs. It should also be understood that terms such as those defined in general dictionaries should be understood to have a meaning consistent with the meaning in the context of the prior art, and unless those terms are specifically defined as here, those terms will not be interpreted in idealized or overly formal meanings.

The technical solutions of the present disclosure and how the technical solutions of the present disclosure solve the above technical problems are described in detail below with specific embodiments. The following specific embodiments can be combined with each other, and the same or similar concepts or processes may not be repeated in some embodiments. The embodiments of the present disclosure will be described below in conjunction with the accompanying drawings.

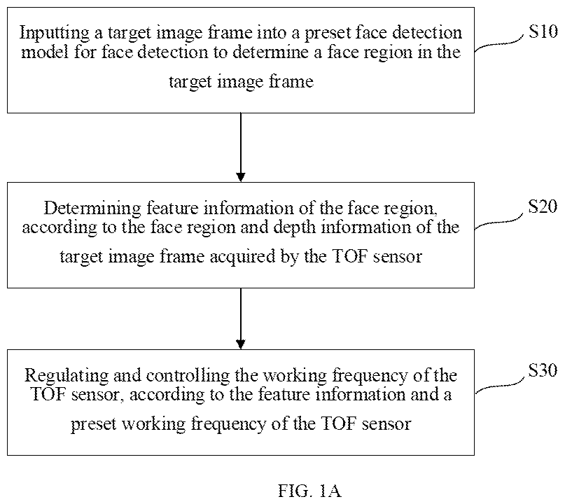

Some embodiments of the present disclosure provide a method for controlling a working frequency of a TOF sensor, the schematic flowchart of the method is shown in FIG. 1A, and the method includes:

S10, inputting a target image frame into a preset face detection model for face detection to determine a face region in the target image frame.

S20, determining feature information of the face region, according to the face region and depth information of the target image frame acquired by the TOF sensor.

S30, regulating and controlling the working frequency of the TOF sensor, according to the feature information and a preset working frequency of the TOF sensor.

For example, in some embodiments, the feature information includes an average depth value of the face region, in this case, as shown in FIG. 1B, the method includes:

S101, inputting a target image frame into a preset face detection model for face detection to determine a face region in the target image frame.

S102, determining local depth information corresponding to respective parts of the face region, according to the face region and the depth information of the target image frame acquired by the TOF sensor.

S103, determining the average depth value of the face region, according to the face region and the local depth information.

S104, regulating and controlling the working frequency of the TOF sensor, according to the average depth value and a preset working frequency of the TOF sensor.

That is, step S10 in FIG. 1A includes step S101 in FIG. 1B, step S20 in FIG. 1A includes steps S102 and S103 in FIG. 1B, and step S30 in FIG. 1A includes step S104 in FIG. 1B.

For example, in other embodiments, the feature information includes an average depth value of the face region, and a deviation ratio between a center point of the face region and a center point of the target image frame, in this case, as shown in FIG. 1C, the method includes:

S101, inputting a target image frame into a preset face detection model for face detection to determine a face region in the target image frame.

S102, determining local depth information corresponding to respective parts of the face region, according to the face region and the depth information of the target image frame acquired by the TOF sensor.

S103, determining the average depth value of the face region, according to the face region and the local depth information.

S105, determining the deviation ratio between a center point of the face region and a center point of the target image frame, according to the target image frame and the face region.

S106, regulating and controlling a working frequency of the TOF sensor, according to the deviation ratio, the average depth value, and a preset working frequency of the TOF sensor.

That is, step S10 in FIG. 1A includes step S101 in FIG. 1C, step S20 in FIG. 1A includes steps S102, 5103, and S105 in FIG. 1C, and step S30 in FIG. 1A includes step S106 in FIG. 1B.

In the embodiments of the present disclosure, inputting a target image frame into a preset face detection model for face detection to determine a face region in the target image frame; determining local depth information corresponding to respective parts of the face region, according to the face region and the depth information of the target image frame acquired by the TOF sensor; determining the average depth value of the face region, according to the face region and the local depth information of the face region; determining the deviation ratio between a center point of the face region and a center point of the target image frame, according to the target image frame and the face region; regulating and controlling the working frequency of the TOF sensor, according to the average depth value and the preset working frequency of the TOF sensor, or according to the deviation ratio, the average depth value, and the preset working frequency of the TOF sensor. In this way, the working frequency of the TOF sensor can be dynamically regulated and controlled, according to the distance between the TOF sensor and the face region or the distance between the TOF sensor and the face region and the degree (i.e., deviation ratio) to which the center point of the face region deviates from the center point of the target image frame. If the distance between the TOF sensor and the face region is farther, or if the distance between the TOF sensor and the face region is farther and the deviation ratio is larger, the working frequency of the TOF sensor is increased in real time, thus improving the security of payment; if the distance between the TOF sensor and the face region is closer, or if the distance between the TOF sensor and the face region is closer and the deviation ratio is smaller, the working frequency of the TOF sensor is reduced in real time, thus saving power and reducing power consumption, which will significantly improve the user experience.

Optionally, the respective parts of the face region can be respective pixels in the face region, and the local depth information can include the depth information corresponding to each pixel. Or, the respective parts of the face region may also include the mouth, eyes, nose, eyebrows, etc. in the face. Therefore, the local depth information may include a plurality of depth information, such as local depth information corresponding to the mouth, local depth information corresponding to the eyes, local depth information corresponding to the nose, and local depth information corresponding to the eyebrows, etc. Under the circumstance, for example, the local depth information corresponding to the mouth may represent an average value of the depth information corresponding to a mouth region, or may represent the depth information corresponding to respective pixels in the mouth region. It should be noted that the respective parts of the face region can be divided according to the actual situation, and the present disclosure does not specifically limit this. Hereinafter, the embodiments of the present disclosure are described by taking a case that the respective parts of the face region are respective pixels in the face region as an example, namely taking a case that the local depth information is the depth information corresponding to the respective pixels as an example.

Optionally, before inputting the target image frame into the preset face detection model for face detection, that is, before performing step S101, the method further includes:

acquiring a plurality of image frames to be processed, and acquiring and determining depth information of respective image frames to be processed (i.e., the plurality of image frames to be processed that are acquired) through the TOF sensor.

Optionally, inputting the target image frame into the preset face detection model for face detection to determine the face region in the target image frame, includes:

inputting any image frame to be processed among the plurality of image frames to be processed into the preset face detection model for face detection, if a face is detected, taking the any image frame to be processed as the target image frame, and determining the face region in the target image frame.

It should be noted that, in a case where the face region of an image frame to be processed is not determined during performing the face detection on the image frame to be processed, after the target image frame is determined, the target image frame can be input into the preset face detection model again for the face detection to determine the face region of the target image frame. Therefore, inputting the target image frame into the preset face detection model for face detection to determine the face region in the target image frame, can include: performing the face detection on any image frame to be processed among the plurality of image frames to be processed (for example, the face detection can be performed by the preset face detection model), and if a face is detected, taking the any image frame to be processed as the target image frame; inputting the target image frame into the preset face detection model for face detection to determine the face region in the target image frame.

For example, the target image frame includes at least one human face.

For example, the method for controlling the working frequency of the TOF sensor can be applied to an electronic system, and the electronic system can include a plurality of applications (app), an image acquisition device, a TOF sensor, etc., and the applications can include a WeChat application, an Alipay application, etc. The image acquisition device is used to acquire the plurality of image frames to be processed. For example, the image acquisition device can be turned on under the control of a preset application among the applications, thereby acquiring the plurality of image frames to be processed.

For example, the image acquisition device can include a camera, etc.

For example, if no face is detected in the any image frame to be processed, selecting a next image frame to be processed from the plurality of image frames to be processed, and performing the above-mentioned face detection process again on the next image frame to be processed. It should be noted that if no face is detected in the plurality of image frames to be processed, it means that there is no target image frame among the plurality of image frames to be processed, in this case, it can be judged whether to end the preset application, or to control the image acquisition device through the preset application to acquire image frames to be processed again.

For example, the plurality of image frames to be processed can be a plurality of image frames of different scenes, or a plurality of image frames of the same scene. For example, the plurality of image frames to be processed can be image frames obtained by shooting the same scene at different distances.

Optionally, in step S102, determining local depth information corresponding to respective parts of the face region, according to the face region and the depth information of the target image frame acquired by the TOF sensor, can include: determining the local depth information corresponding to respective parts of the face region, according to a feature parameter of the face region and the depth information of the target image frame.

For example, in step S105 shown in FIG. 1C, determining the deviation ratio between the center point of the face region and the center point of the target image frame, according to the target image frame and the face region, can include: determining the deviation ratio, according to the feature parameter of the face region and a feature parameter of the target image frame.

For example, in some embodiments, the feature parameter of the face region includes a first start value of the face region corresponding to a first direction, a second start value of the face region corresponding to a second direction, a first width parameter of the face region corresponding to the first direction, and a first height parameter of the face region corresponding to the second direction. That is, the step S102 includes determining the local depth information respectively corresponding to the respective parts of the face region, according to the first start value of the face region corresponding to the first direction, the second start value of the face region corresponding to the second direction, the first width parameter of the face region corresponding to the first direction, the first height parameter of the face region corresponding to the second direction, and the depth information of the target image frame.

For example, the feature parameter of the target image frame includes a third start value of the target image frame corresponding to the first direction, a fourth start value of the target image frame corresponding to the second direction, a second width parameter of the target image frame corresponding to the first direction, and a second height parameter of the target image frame corresponding to the second direction. That is, the step S105 shown in FIG. 1C can include determining the deviation ratio, according to the first start value, the second start value, the first width parameter, the first height parameter, the third start value, the fourth start value, the second width parameter, and the second height parameter.

For example, in other examples, the feature parameter of the face region includes a first start value and a first end value of the face region corresponding to a first direction, and a second start value and a second end value of the face region corresponding to a second direction. That is, step S102 includes determining the local depth information respectively corresponding to the respective parts of the face region, according to the first start value and the first end value of the face region corresponding to the first direction, the second start value and the second end value of the face region corresponding to the second direction, and the depth information of the target image frame.

For example, the feature parameter of the target image frame includes a third start value and a third end value of the target image frame corresponding to the first direction, and a fourth start value and a fourth end value of the target image frame corresponding to the second direction. That is, the step S105 shown in FIG. 1C can include determining the deviation ratio, according to the first start value, the first end value, the second start value, the second end value, the third start value, the third end value, the fourth start value, and the fourth end value.

It should be noted that step S105 can also include determining the deviation ratio, according to the first start value, the second start value, the first width parameter, the first height parameter, the third start value, the third end value, the fourth start value, and the fourth end value; or, step S105 can also include determining the deviation ratio, according to the first start value, the first end value, the second start value, the second end value, the third start value, the fourth start value, the second width parameter, and the second height parameter.

For example, the deviation ration represents the degree to which the center point of the face region deviates from the center point of the target image frame.

For example, the face region is located in a face region plane coordinate system, the first direction of the face region is parallel to a horizontal axis direction of the face region plane coordinate system, that is, the first direction of the face region includes the horizontal axis direction of the face region plane coordinate system; and the second direction of the face region is parallel to a longitudinal axis direction of the face region plane coordinate system, that is, the second direction of the face region includes the longitudinal axis direction of the face region plane coordinate system.

For example, the target image frame can be represented as Targ (x10, y10, width10, height10), that is, the third start value is x10, the third end value is x11, the second width parameter is width10, and the second height parameter is height10. In a case where a start point of the target image frame is the origin of the face region plane coordinate system, the third start value x10 and the fourth start value y10 are both 0, and the resolution of the target image frame is represented as width10*height10.

For example, the target image frame can also be represented as Targ (x10, y10, x11, y11), that is, the third start value is x10, the third end value is x11, the fourth start value is y10, the fourth end value is y11. Optionally, the second width parameter width10 of the target image frame can be determined according to the third start value x10 and the third end value x11, where width10=|x11−x10|, that is, the second width parameter width10 may be an absolute value of a difference between the third start value x10 and the third end value x11. The second height parameter height10 of the target image frame can be determined according to the fourth start value y10 and the fourth end value y11, where height10=|y11−y10|, that is, the second height parameter height10 may be an absolute value of a difference between the fourth start value y10 and the fourth end value y11.

For example, x10, y10, width10, height10, x11, and y11 can all be positive numbers. For example, in an embodiment, x11 is greater than x10 and y11 is greater than y10.

Optionally, the face region can be a rectangular region. In a case where the face region is represented as Rect (x0, y0, width0, height0), extracting the local depth information Depth (xi, yi) corresponding to the face region from the depth information Depth (x, y) of the current target image frame, according to the face region Rect (x0, y0, width0, height0) and the depth information of the target image frame, where the first start value of the face region corresponding to the first direction is x0, the second start value of the face region corresponding to the second direction is y0, the first width parameter of the face region corresponding to the first direction is width0, the first height parameter of the face region corresponding to the second direction is height0, the depth information of the target image frame is Depth (x, y), the range of xi is (x0, x0+width0), and the range of yi is (y0, y0+height0).

Optionally, in a case where the face region is represented as Rect (x0, y0, x1, y1), extracting the local depth information Depth (xi, yi) corresponding to the face region from the depth information Depth (x, y) of the current target image frame, according to the face region Rect (x0, y0, x1, y1) and the depth information of the target image frame, where the first start value of the face region corresponding to the first direction is x0, the first end value of the face region corresponding to the first direction is x1, the second start value of the face region corresponding to the second direction is y0, and the second end value of the face region corresponding to the second direction is y1, the depth information of the target image frame is Depth (x, y), the range of xi is (x0, x1), and the range of yi is (y0, y1).

For example, x0, y0, width0, height0, x1, and y1 can all be positive numbers. For example, in an embodiment, x1 is greater than x0 and y1 is greater than y0.

Optionally, the first width parameter width0 of the face region can be determined according to the first start value x0 and the first end value x1, where width0=|x1−x0|, that is, the first width parameter width0 can be an absolute value of a difference between the first start value x0 and the first end value x1. The first height parameter of the face region can be determined as height0 according to the second start value y0 and the second end value y1, where height0=|y1−y0|, that is, the first height parameter height0 can be an absolute value of a difference between the second start value y0 and the second end value y1.

It should be noted that the depth information Depth (x, y) of the target image frame is also determined based on the face region plane coordinate system. The face region can also be a circular region, etc.

Optionally, in a case where the feature parameter of the face region includes the first start value, the second start value, the first width parameter, and the first height parameter, in step S103, determining an average depth value of the face region, according to the face region and the local depth information of the face region, includes:

summing the local depth information corresponding to the respective parts of the face region to determine a first parameter;

determining a second parameter, according to a product of the first width parameter of the face region and the first height parameter of the face region;

dividing the first parameter by the second parameter to determine the average depth value.

Optionally, calculating the total depth information sum of respective points corresponding to the local depth information Depth (xi, yi) of the face region, and calculating the average depth value avg0, according to the total depth information sum, the first width parameter width0 of the face region, and the first height parameter height0 of the face region, for example, the average depth value avg0=sum/(width0×height0).

Optionally, in a case where the feature parameter of the face region includes the first start value, the first end value, the second start value, and the second end value, in step S103, determining an average depth value of the face region, according to the face region and the local depth information, includes: summing the local depth information to determine a first parameter; determining a second parameter, according to a product of an absolute value of a difference between the first end value and the first start value and an absolute value of a difference between the second end value and the second start value; and dividing the first parameter by the second parameter to determine the average depth value.

Optionally, calculating the total depth information sum of respective points corresponding to the local depth information Depth (xi,yi) of the face region, and calculating the average depth value avg0, according to the total depth information sum, the first end value x0, the first start value x1, the second end value y0, and the second start value y1 of the face region, for example, the average depth value avg0=sum/(|x1−x0|×|y1−y0|).

For example, determining the second parameter, according to the product of the absolute value of the difference between the first end value and the first start value and the absolute value of the difference between the second end value and the second start value, can include: determining the first width parameter according to the absolute value of the difference between the first end value and the first start value, determining the first height parameter according to the absolute value of the difference between the second end value and the second start value; and multiplying the first width parameter with the first height parameter to determine the second parameter.

Optionally, in step S104, in a case where the feature parameter of the face region includes the first start value, the second start value, the first width parameter, and the first height parameter, regulating and controlling the working frequency of the TOF sensor, according to the average depth value and the preset working frequency of the TOF sensor, includes:

determining a third parameter, according to the product of the average depth value and the preset working frequency of the TOF sensor;

summing the first width parameter of the face region and the first height parameter of the face region to determine a fourth parameter;

dividing the third parameter by the fourth parameter to determine an updated working frequency of the TOF sensor.

Optionally, in step S104, M a case where the feature parameter of the face region includes the first start value, the first end value, the second start value, and the second end value, regulating and controlling the working frequency of the TOF sensor, according to the average depth value and the preset working frequency of the TOF sensor, includes:

determining a third parameter, according to the product of the average depth value and the preset working frequency;

summing an absolute value of a difference between the first end value and the first start value and an absolute value of a difference between the second end value and the second start value to determine a fourth parameter;

dividing the third parameter by the fourth parameter to determine the updated working frequency of the TOF sensor.

For example, the updated working frequency of the TOF sensor is less than an upper threshold of the working frequency of the TOF sensor. For example, the updated working frequency of the TOF sensor is greater than a lower threshold of the working frequency of the TOF sensor.

Optionally, the updated working frequency of the TOF sensor f1=f0×avg0/(width0+height0), or, the updated working frequency of the TOF sensor f1=f0×avg0/(|x1−x0|+|y1−y0|), the preset working frequency of the TOF sensor is f0, the first width parameter of the face region is width0, the first height parameter of the face region is height0, and the average depth value is avg0. The farther the distance between the TOF sensor and the face region, that is, the larger the average depth value avg0, the higher the acquisition frequency (that is, the updated working frequency of the TOF sensor), thus improving the security of payment; the closer the distance between the TOF sensor and the face region, that is, the smaller the average depth value avg0, the lower the acquisition frequency, thus saving power and reducing power consumption.

For example, in step S105, in a case where the feature parameter of the face region includes the first start value, the second start value, the first width parameter, and the first height parameter, and the feature parameter of the target image frame includes the third start value, the fourth start value, the second width parameter, and the second height parameter, determining the deviation ratio, according to the feature parameter of the face region and the feature parameter of the target image frame, includes:

determining a first center point parameter of the center point of the face region, according to the first width parameter and the first start value, for example, summing the first start value and half of the first width parameter to determine the first center point parameter of the center point of the face region;

determining a second center point parameter of the center point of the face region, according to the first height parameter and the second start value, for example, summing the second start value and half of the first height parameter to determine the second center point parameter of the center point of the face region;

determining a third center point parameter of the center point of the target image frame, according to the second width parameter and the third start value, for example, summing the third start value and half of the second width parameter to determine the third center point parameter of the center point of the target image frame;

determining a fourth center point parameter of the center point of the target image frame, according to the second height parameter and the fourth start value, for example, summing the fourth start value and half of the second height parameter to determine the fourth center point parameter of the center point of the target image frame;

determining a fifth parameter, according to the first center point parameter, the third center point parameter, the second center point parameter, and the fourth center point parameter, for example, calculating the square root of the sum of the square of the difference between the first center point parameter and the third center point parameter and the square of the difference between the second center point parameter and the fourth center point parameter to determine the fifth parameter, where the fifth parameter represents a distance between the center point of the face region and the center point of the target image frame;

determining a sixth parameter, according to the second width parameter and the second height parameter, for example, calculating the square root of the sum of the square of half of the second width parameter and the square of half of the second height parameter to determine the sixth parameter, where the sixth parameter represents half of the diagonal length of the target image frame;

dividing the fifth parameter by the sixth parameter to determine the deviation ratio.

For example, the first center point parameter cx1 is represented as cx1=x0+(width0)/2, the second center point parameter cy1 is represented as cy1=y0+(height0)/2, the third center point parameter cx2 is represented as cx2=x10+(width10)/2, and the fourth center point parameter cy2 is represented as cy2=y10+(height10)/2. The fifth parameter dis is represented as dis=sqrt((cx2−cx1)×(cx2−cx1)+(cy2−cy1)×(cy2−cy1)), and the sixth parameter dis_pre is represented as dis_pre=sqrt((width10)/2×(width10)/2+(height10)/2×(height10)/2). The deviation ratio dratio is represented as dratio=dis/dis_pre.

For example, in step S105, in a case where the feature parameter of the face region includes the first start value, the first end value, the second start value, and the second end value, and the feature parameter of the target image frame includes the third start value, the third end value, the fourth start value, and the fourth end value, determining the deviation ratio between the center point of the face region and the center point of the target image frame, according to the target image frame and the face region, includes:

determining a first center point parameter of the center point of the face region, according to the first end value and the first start value, for example, summing the first start value and half of the difference between the first end value and the first start value to determine the first center point parameter of the center point of the face region;

determining a second center point parameter of the center point of the face region, according to the second end value and the second start value, for example, summing the second start value and half of the difference between the second end value and the second start value to determine the second center point parameter of the center point of the face region;

determining a third center point parameter of the center point of the target image frame, according to the third end value and the third start value, for example, summing the third start value and half of the difference between the third end value and the third start value to determine the third center point parameter of the center point of the target image frame;

determining a fourth center point parameter of the center point of the target image frame, according to the fourth end value and the fourth start value, for example, summing the fourth start value and half of the difference between the fourth end value and the fourth start value to determine the fourth center point parameter of the center point of the target image frame;

determining a fifth parameter, according to the first center point parameter, the third center point parameter, the second center point parameter, and the fourth center point parameter, for example, calculating the square root of the sum of the square of the difference between the first center point parameter and the third center point parameter and the square of the difference between the second center point parameter and the fourth center point parameter to determine the fifth parameter, where the fifth parameter represents a distance between the center point of the face region and the center point of the target image frame;

determining a sixth parameter, according to the third end value, the third start value, the fourth end value, the fourth start value, for example, calculating the square root of the sum of the square of half of an absolute value of a difference between the third end value and the third start value and the square of half of an absolute value of a difference between the fourth end value and the fourth start value to determine the sixth parameter, where the sixth parameter represents half of the diagonal length of the target image frame;

dividing the fifth parameter by the sixth parameter to determine the deviation ratio.

For example, the first center point parameter cx1 is represented as cx1=x0+(|x0−x1|)/2, the second center point parameter cy1 is represented as cy1=y0+(|y1−y0|)/2, the third center point parameter cx2 is represented as cx2=x10+(|x11−x10|)/2, and the fourth center point parameter cy2 is represented as cy2=y10+(|y11−y10|)/2. The fifth parameter dis is represented as dis=sqrt((cx2−cx1)×(cx2−cx1)+(cy2−cy1)×(cy2−cy1)), and the sixth parameter dis_pre is represented as dis_pre=sqrt((|x11−x10|)/2×(|x11−x10|)/2+(|y11−y10|)/2×(|y11−y10|)/2). The deviation ratio dratio is represented as dratio=dis/dis_pre.

For example, in step S106, in a case where the feature parameter of the face region includes the first start value, the second start value, the first width parameter, and the first height parameter, and the feature parameter of the target image frame includes the third start value, the fourth start value, the second width parameter, and the second height parameter, regulating and controlling the working frequency of the TOF sensor, according to the average depth value, the deviation ratio, and the preset working frequency of the TOF sensor, includes:

determining a third parameter, according to the product of the average depth value and the preset working frequency;

summing the first width parameter of the face region and the first height parameter of the Lace region to determine a fourth parameter,

determining a seventh parameter, according to a product of the deviation ratio and the preset working frequency;

dividing the third parameter by the fourth parameter to determine an eighth parameter;

summing the seventh parameter and the eighth parameter to determine an updated working frequency of the TOF sensor.

Optionally, in step S106, in a case where the feature parameter of the face region includes the first start value, the first end value, the second start value, and the second end value, and the feature parameter of the target image frame includes the third start value, the third end value, the fourth start value, and the fourth end value, regulating and controlling the working frequency of the TOF sensor, according to the average depth value, the deviation ratio, and the preset working frequency of the TOF sensor, includes:

determining a third parameter, according to the product of the average depth value and the preset working frequency;

summing an absolute value of a difference between the first end value and the first start value and an absolute value of a difference between the second end value and the second start value to determine a fourth parameter;

determining a seventh parameter, according to a product of the deviation ratio and the preset working frequency;

dividing the third parameter by the fourth parameter to determine an eighth parameter;

summing the seventh parameter and the eighth parameter to determine an updated working frequency of the TOF sensor.

For example, the updated working frequency is less than an upper threshold of the working frequency of the TOF sensor. For example, the updated working frequency of the TOF sensor is greater than a lower threshold of the working frequency of the TOF sensor.

Optionally, the preset working frequency of the TOF sensor is f0, the first start value of the face region is x0, the first end value of the face region is x1, the second start value of the face region is y0, the second end value of the face region is y1, the first width parameter of the face region is width0, the first height parameter of the face region is height0, the average depth value is avg0, and the deviation ratio is dratio. In some examples, the third parameter is represented as f0×avg0, the fourth parameter is represented as width0+height0, the seventh parameter is represented as f0×dratio, and the eighth parameter is represented as (f0×avg0)/(width0+height0), so that the updated working frequency of the TOF sensor is represented as f1=(f0×avg0)/(width0+height0)+f0×dratio; in other examples, the third parameter is represented as f0×avg0, the fourth parameter is represented as |x1−x0|+|y1−y0|, the seventh parameter is represented as f0×dratio, and the eighth parameter is represented as (f0×avg0)/(|x1−x0|+|y1−y0|), so that the updated working frequency of the TOF sensor is represented as f1=(f0×avg0)/(|x1−x0|+|y1−y0|)+f0×dratio. The farther the distance between the TOF sensor and the face region, that is, the larger the average depth value avg0, and the larger the deviation ratio dratio, the higher the acquisition frequency (that is, the updated working frequency of the TOF sensor), thus improving the security of payment; the closer the distance between the TOF sensor and the face region, that is, the smaller the average depth value avg0, and the smaller the deviation ratio dratio, the lower the acquisition frequency, thus saving power and reducing power consumption.

For example, after determining the updated working frequency of the TOF sensor, the method may further include storing the updated working frequency in an electronic system, so as to control the acquisition frequency of the TOF sensor in real time and improve the security of the payment process.

Optionally, before determining the feature information of the face region, according to the face region and the depth information, which is acquired, of the target image frame, that is, before performing step S20, the method further includes:

judging whether a preset application is a payment type application according to an identity of the preset application;

where the preset application is a payment type application, performing the step of determining the feature information of the face region, according to the face region and the acquired depth information of the target image frame;

where the preset application is not a payment type application, not regulating and controlling the working frequency of the TOF sensor.

That is, determining the feature information of the face region, according to the face region and the acquired depth information of the target image frame, includes:

If the preset application is a payment type application, determining the feature information of the face region, according to the face region and the acquired depth information of the target image frame. Then, the operation of regulating and controlling the working frequency of the TOF sensor, according to the feature information and the preset working frequency of the TOF sensor is performed. That is, in the present disclosure, only in a case where the preset application is a payment type application, the working frequency of the TOF sensor is regulated.

In a case where the preset application is not a payment type application, the working frequency of the TOF sensor is not changed, that is, the TOF sensor operates according to the preset working frequency

For example, the preset application is configured to control an image acquisition device to acquire the target image frame.

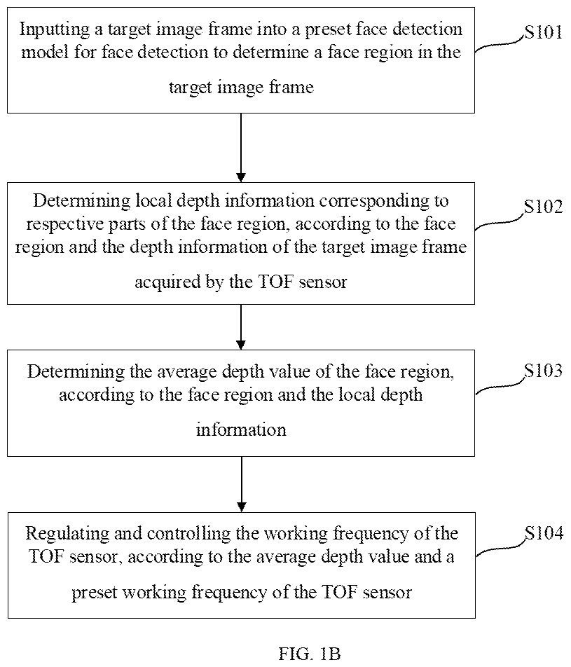

Some embodiments of the present disclosure provide another method for controlling the working frequency of the TOF sensor, the schematic flowchart of the method is shown in FIG. 2. It should be noted that the example shown in FIG. 2 takes the feature information including the average depth value as an example. As shown in FIG. 2, the method includes:

S201, turning on a function for controlling the working frequency of the TOF sensor in a payment scenario.

S202, acquiring an ID of a preset application that activates a camera sensor (i.e., an image acquisition device).

Optionally, the ID of the preset application is represented by a character string, and the ID of the preset application is an identity for distinguishing various applications, such as a camera application, a WeChat application, an Alipay application, or a certain bank application, etc.

S203, loading a preset parameter table corresponding to the working frequency of the TOF sensor.

Optionally, respective parameters in the preset parameter table can include, for example, a preset acquisition frequency f0 of the TOF sensor, the upper threshold of the working frequency, the lower threshold of the working frequency, a frequency optimization coefficient of the TOF sensor, etc. The preset acquisition frequency ID of the TOF sensor is also the preset working frequency f0 of the TOF sensor described above. It should be noted that each parameter in the preset parameter table can also be manually adjusted by the user.

S204, turning on the image acquisition device to acquire a preview video stream.

Optionally, the image acquisition device is a camera, such as a mobile phone camera.

S205, acquiring a preview data frame according to the preview video stream; and turning on the TOF sensor to acquire a depth data frame.

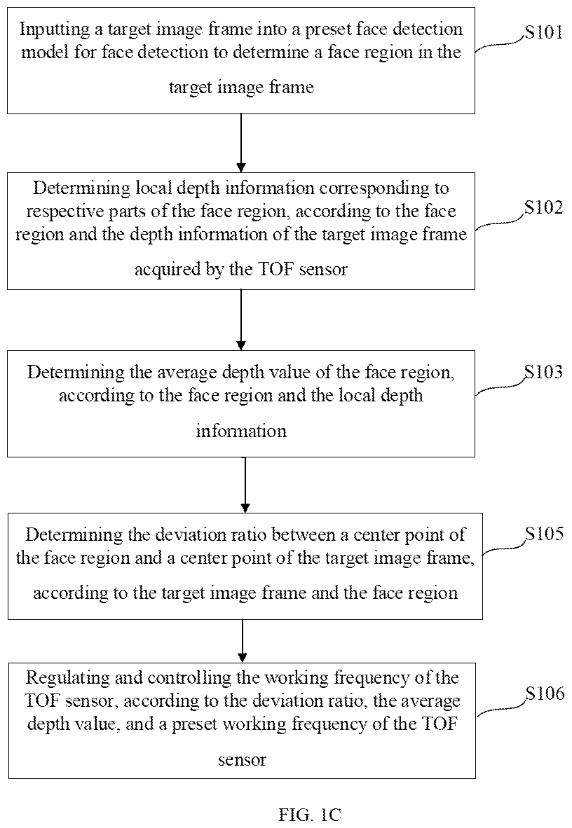

Optionally, the preview data frame is the image frame to be processed described above, and the depth data frame is a depth image corresponding to the image frame to be processed (that is, the depth information described above), FIG. 3 is the depth image obtained by the TOF sensor.

S206, inputting the preview data frame into the face detection model, performing face detection on the preview data frame by the face detection model, and judging whether there is a face in the preview data frame, if there is a face, the operation of S207 is performed, and if there is no face, the operation of S213 is performed.

Optionally, the face detection model may detect face key points, the detection of the face key points can include the following operations: a): collecting a considerable number (i.e., 100,000) of face images (base database); b): accurately labeling the face key points on the face images in step a) (including but not limited to: face contour points, eye contour points, nose contour points, eyebrow contour points, forehead contour points, upper lip contour points, lower lip contour points, etc.); c): dividing the accurately labeled data in step b) into a training set, a verification set, and a test set according to a certain proportion; d): training the face detection model (neural network) with the training set in step c), and verifying intermediate results obtained from the face detection model during the training process with the verification set (adjusting the training parameter of the face detection model in real time), when the training accuracy and the verification accuracy both reach a certain threshold, the training process is stopped and a trained face detection model is obtained; e): testing the trained face detection model obtained in step d) with the test set to measure the performance and ability of the trained face detection model.

S207, acquiring a face region in the preview data frame.

Optionally, the face region (that is, the face region described above) in the preview data frame is represented as Rect(x0, y0, width0, height0), and the face region is located in the face region plane coordinate system. In the horizontal axis direction of the face region plane coordinate system, a start value of the face region is x0, in the longitudinal axis direction of the face region plane coordinate system, a start value of the face region is y0. The first width parameter of the face region is width0, that is, in the horizontal axis direction of the face region plane coordinate system, the width of the face region is width0. The first height parameter of the face region is height0, that is, in the longitudinal axis direction of the face region plane coordinate system, the height of the face region is height0.

S208, judging whether the preset application in S202 is a payment type application, where the preset application is a payment type application, the operation of S209 is performed, and where the preset application is not a payment type application, the operation of S213 is performed.

S209, acquiring local depth information corresponding to the face region from depth information corresponding to a current preview data frame according to the face region.

Optionally, acquiring the local depth information Depth(xi, yi) corresponding to the face region from the depth information Depth(x, y) corresponding to the current preview data frame according to the face region Rect(x0, y0, width0, height0), where the range of xi is (x0, x0+width0), and the range of yi is (y0, y0+height0).

S210, determining an average depth value avg0 of the local depth information Depth(xi, yi).

Optionally, the processor can run the following program to execute the operation of determining the average depth value avg0 of the local depth information Depth(xi, yi):

for(long x=x0;x<x0+width0;++x){

for(long y=y0;y<y0+height0;++y){
sum=sum+Depth(x,y);
}

}
float avg0=sum/(width0×height0)

S211, regulating the working frequency of the TOF sensor in real time, according to the average depth value avg0 of the face region and the preset working frequency f0 of the TOF sensor to determine the updated working frequency of the TOF sensor.

Optionally, the updated working frequency f1 of the TOF sensor can be represented as f1=f0×avg0/(width0+height0).

The farther the distance between the TOF sensor and the face region, that is, the larger the average depth value avg0, the higher the updated working frequency, thus improving the security of payment; the closer the distance between the TOF sensor and the face region, that is, the smaller the average depth value avg0, the lower the updated working frequency, thus saving power and reducing power consumption.

S212, updating the updated working frequency of the TOF sensor (i.e., the working frequency of the TOF sensor adjusted in real time) to the electronic system.

S213, judging whether the preset application ends, if the preset application ends, the operation of S214 is performed, and if the preset application does not end, the operation of S204 is performed.

S214, turning off the function for controlling the working frequency of the TOF sensor in the payment scenario.

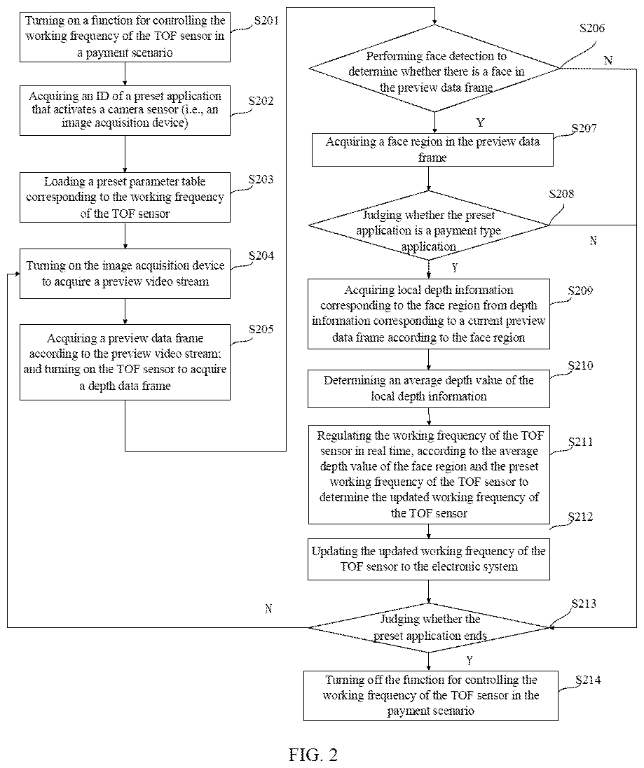

Optionally, as shown in FIG. 4, in the face region plane coordinate system, the abscissa is the average depth avg0, and the ordinate is the working frequency f of the TOF sensor. In a case where the preset application is a non-payment type application, such as a camera application, a live broadcast application, etc., the working frequency of the TOF sensor is adjusted with the average depth avg0.

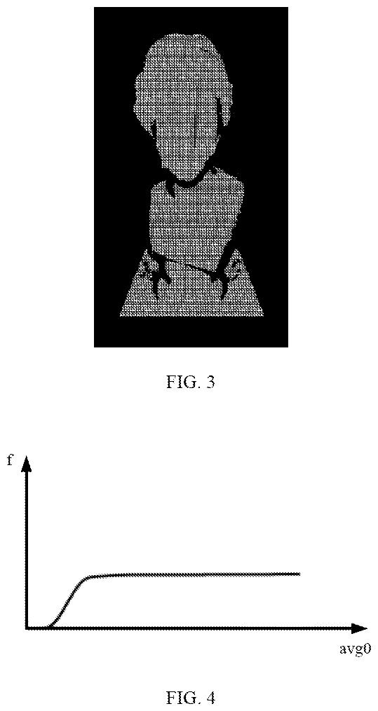

Optionally, as shown in FIG. 5, the abscissa is the average depth avg0, and the ordinate is the working frequency f of the TOF sensor. In a case where the preset application is a payment type application, such as a WeChat application, an Alipay application, etc., a point A is the moment when the payment application is started, and the working frequency of the TOF sensor is regulated with the average depth avg0, the larger the average depth avg0, the higher the working frequency of the TOF sensor, so as to ensure the security of the payment process. In a case where the average depth value avg0 of the abscissa rises to a certain value, when the working frequency (acquisition frequency) of the TOF sensor reaches the upper threshold of the working frequency, from this point, even if the average depth avg0 continues to increase, the working frequency of the TOF sensor does not change.

The embodiments of the present disclosure have at least the following beneficial effects:

The method for controlling the working frequency of the TOF sensor provided by the embodiments of the present disclosure achieves the dynamic regulation and control of the working frequency of the TOF sensor, if the distance between the TOF sensor and the face region is farther, the working frequency of the TOF sensor is increased in real time, thus improving the security of payment; if the distance between the TOF sensor and the face region is closer, the working frequency of the TOF sensor is reduced in real time, thus saving power and reducing power consumption, which significantly improve the user experience.

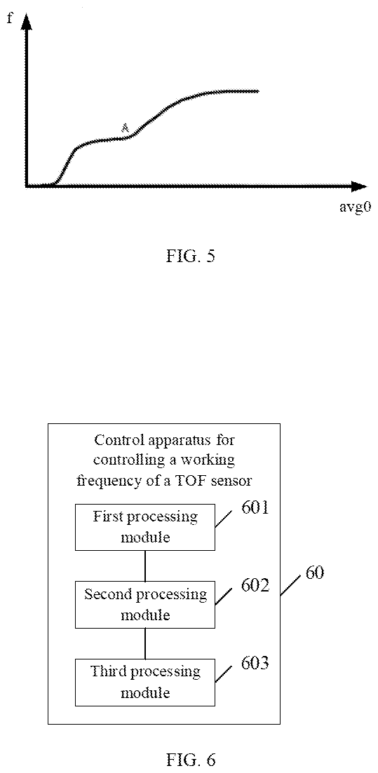

Based on the same inventive concept, the embodiments of the present disclosure also provide a control apparatus for controlling a working frequency of a TOF sensor, the structural schematic diagram of the apparatus is shown in FIG. 6, and the control apparatus 60 for controlling the working frequency of the TOF sensor includes a first processing module 601, a second processing module 602, and a third processing module 603.

The first processing module 601 is configured for inputting a target image frame into a preset face detection model for face detection to determine a face region in the target image frame.

The second processing module 602 is configured for determining feature information of the face region, according to the face region and depth information of the target image frame acquired by the TOF sensor.

The third processing module 603 is configured for regulating and controlling a working frequency of the TOF sensor, according to the feature information and a preset working frequency of the TOF sensor.

Optionally, the first processing module 601 is further configured to acquire a plurality of image frames to be processed, and the TOF sensor is configured to acquire and determine the depth information of each image frame to be processed.

Optionally, the first processing module 601 is specifically configured for inputting any image frame to be processed among the plurality of image frames to be processed into the preset face detection model for face detection, and if a face is detected, taking the any image frame to be processed as the target image frame, and determining the face region in the target image frame.

Optionally, in some embodiments, the feature information includes an average depth value of the face region, the second processing module 602 is specifically configured for determining local depth information corresponding to respective parts of the face region, according to the face region and the depth information of the target image frame acquired by the TOF sensor; determining the average depth value, according to the face region and the local depth information. The third processing module 603 is configured for regulating and controlling the working frequency of the TOF sensor, according to the average depth value and the preset working frequency of the TOF sensor.

Optionally, the second processing module 602 is specifically configured for determining the local depth information corresponding to respective parts of the face region, according to the feature parameter of the face region and the depth information of the target image frame.

For example, in some examples, the feature parameter of the face region includes a first start value of the face region corresponding to a first direction, a second start value of the face region corresponding to a second direction, a first width parameter of the face region corresponding to the first direction, a first height parameter of the face region corresponding to the second direction. Under the circumstance, the second processing module 602 is specifically configured for determining the local depth information corresponding to the respective parts of the face region, according to the first start value of the face region corresponding to the first direction, the second start value of the face region corresponding to the second direction, the first width parameter of the face region corresponding to the first direction, the first height parameter of the face region corresponding to the second direction, and the depth information of the target image frame.

For example, in other examples, the feature parameter of the face region includes a first start value and a first end value of the face region corresponding to a first direction, and a second start value and a second end value of the face region corresponding to a second direction. Under the circumstance, the second processing module 602 is specifically configured for determining the local depth information corresponding to the respective parts of the face region, according to the first start value and the first end value of the face region corresponding to the first direction, the second start value and the second end value of the face region corresponding to the second direction, and the depth information of the target image frame.

For example, the face region is located in a face region plane coordinate system, the first direction of the face region is parallel to a horizontal axis direction of the face region plane coordinate system, that is, the first direction of the face region includes the horizontal axis direction of the face region plane coordinate system; the second direction of the face region is parallel to a longitudinal axis direction of the face region plane coordinate system, that is, the second direction of the face region includes the longitudinal axis direction of the face region plane coordinate system.

Optionally, in a case where the feature parameter of the face region includes the first start value, the first end value, the second start value, and the second end value, the second processing module 602 is also specifically configured for slimming the local depth information corresponding to the respective parts of the face region to determine a first parameter; determining a second parameter, according to a product of the first width parameter of the face region and the first height parameter of the face region; and dividing the first parameter by the second parameter to determine the average depth value.

Optionally, in a case where the feature parameter of the face region includes the first start value, the second start value, the first width parameter, and the first height parameter, the second processing module 602 is also specifically configured for summing the local depth information corresponding to the respective parts of the face region to determine a first parameter; determining a second parameter, according to a product of an absolute value of a difference between the first end value and the first start value and an absolute value of a difference between the second end value and the second start value; and dividing the first parameter by the second parameter to determine the average depth value.

Optionally, in a case where the feature parameter of the face region includes the first start value, the second start value, the first width parameter, and the first height parameter, the third processing module 603 is specifically configured for determining a third parameter, according to the product of the average depth value and the preset working frequency of the TOF sensor; summing the first width parameter of the face region and the first height parameter of the face region to determine a fourth parameter; and dividing the third parameter by the fourth parameter to determine the updated working frequency of the TOF sensor.

Optionally, in a case where the feature parameter of the face region includes the first start value, the first end value, the second start value, and the second end value, the third processing module 603 is specifically configured for determining a third parameter, according to the product of the average depth value and the preset working frequency; summing an absolute value of a difference between the first end value and the first start value and an absolute value of a difference between the second end value and the second start value to determine a fourth parameter; and dividing the third parameter by the fourth parameter to determine the updated working frequency of the TOF sensor.

For example, the updated working frequency is less than an upper threshold of the working frequency of the TOF sensor.

Optionally, in other embodiments, the feature information includes the average depth value of the face region and the deviation ratio between a center point of the face region and a center point of the target image frame, the second processing module 602 is specifically configured for determining the local depth information corresponding to the respective parts of the face region, according to the face region and the depth information of the target image frame acquired by the TOF sensor; determining the average depth value, according to the face region and the local depth information; determining the deviation ratio, according to the target image frame and the face region. The third processing module 603 is specifically configured for regulating and controlling the working frequency of the TOF sensor, according to the deviation ratio, the average depth value, and the preset working frequency of the TOF sensor.

It should be noted that the process of determining the average depth value by the second processing module 602 can refer to the above related description, and the repeated parts will not be repeated here.

Optionally, the second processing module 602 is also specifically configured for determining the deviation ratio, according to the feature parameter of the face region and the feature parameter of the target image frame.

Optionally, in some embodiments, in a case where the feature parameter of the face region includes the first start value, the second start value, the first width parameter, and the first height parameter, and the feature parameter of the target image frame includes the third start value, the fourth start value, the second width parameter, and the second height parameter, the second processing module 602 is also specifically configured for summing the first start value and half of the first width parameter to determine a first center point parameter of the center point of the face region; summing the second start value and half of the first height parameter to determine a second center point parameter of the center point of the face region; summing the third start value and half of the second width parameter to determine a third center point parameter of the center point of the target image frame; summing the fourth start value and half of the second height parameter to determine a fourth center point parameter of the center point of the target image frame; calculating the square root of the sum of the square of the difference between the first center point parameter and the third center point parameter and the square of the difference between the second center point parameter and the fourth center point parameter to determine the fifth parameter, where the fifth parameter represents a distance between the center point of the face region and the center point of the target image frame; calculating the square root of the sum of the square of half of the second width parameter and the square of half of the second height parameter to determine the sixth parameter, where the sixth parameter represents half of the diagonal length of the target image frame; and dividing the fifth parameter by the sixth parameter to determine the deviation ratio.

Optionally, in other embodiments, in a case where the feature parameter of the face region includes the first start value, the first end value, the second start value, the second end value, and the feature parameter of the target image frame includes the third start value, the third end value, the fourth start value, and the fourth end value, the second processing module 602 is specifically configured for summing the first start value and half of the difference between the first end value and the first start value to determine a first center point parameter of the center point of the face region; summing the second start value and half of the difference between the second end value and the second start value to determine a second center point parameter of the center point of the face region; summing the third start value and half of the difference between the third end value and the third start value to determine a third center point parameter of the center point of the target image frame; summing the fourth start value and half of the difference between the fourth end value and the fourth start value to determine a fourth center point parameter of the center point of the target image frame; calculating the square root of the sum of the square of the difference between the first center point parameter and the third center point parameter and the square of the difference between the second center point parameter and the fourth center point parameter to determine the fifth parameter; calculating the square root of the sum of the square of half of an absolute value of a difference between the third end value and the third start value and the square of half of an absolute value of a difference between the fourth end value and the fourth start value to determine the sixth parameter; and dividing the fifth parameter by the sixth parameter to determine the deviation ratio.

Optionally, in a case where the feature parameter of the face region includes the first start value, the second start value, the first width parameter, and the first height parameter, and the feature parameter of the target image frame includes the third start value, the fourth start value, the second width parameter, and the second height parameter, the third processing module 603 is specifically configured for determining a third parameter, according to the product of the average depth value and the preset working frequency; summing the first width parameter of the face region and the first height parameter of the face region to determine a fourth parameter; determining a seventh parameter, according to a product of the deviation ratio and the preset working frequency; dividing the third parameter by the fourth parameter to determine an eighth parameter; and summing the seventh parameter and the eighth parameter to determine an updated working frequency of the TOF sensor.

Optionally, in a case where the feature parameter of the face region includes the first start value, the first end value, the second start value, and the second end value, and the feature parameter of the target image frame includes the third start value, the third end value, the fourth start value, and the fourth end value, the third processing module 603 is specifically configured for determining a third parameter, according to the product of the average depth value and the preset working frequency; summing an absolute value of a difference between the first end value and the first start value and an absolute value of a difference between the second end value and the second start value to determine a fourth parameter; determining a seventh parameter, according to a product of the deviation ratio and the preset working frequency; dividing the third parameter by the fourth parameter to determine an eighth parameter; summing the seventh parameter and the eighth parameter to determine an updated working frequency of the TOF sensor.

Optionally, the second processing module 602 is also specifically configured for judging whether a preset application is a payment type application according to an identity of the preset application; where the preset application is a payment type application, determining feature information of the face region, according to the face region and the acquired depth information of the target image frame, then regulating and controlling a working frequency of the TOF sensor, according to the feature information and a preset working frequency of the TOF sensor. It should be noted that where the preset application is a non-payment type application, the working frequency of the TOF sensor is regulated and controlled.

The first processing module 601 is configured to perform the operation of step S10 in the method for controlling the working frequency of the TOF sensor described above, the second processing module 602 is configured to perform the operation of step S20 in the method for controlling the working frequency of the TOF sensor described above, and the third processing module 603 is configured to perform the operation of step S30 in the method for controlling the working frequency of the TOF sensor described above. For specific operations performed by the first processing module 601, the second processing module 602, and the third processing module 603, reference can be made to the embodiments of the method for controlling the working frequency of the TOF sensor described above, which will not be repeated here.

For example, in some embodiments of the present disclosure, the first processing module 601, the second processing module 602, and/or the third processing module 603 may be dedicated hardware devices, which are used to achieve some or all functions of the first processing module 601, the second processing module 602, and/or the third processing module 603 as described above. For example, the first processing module 601, the second processing module 602, and/or the third processing module 603 may be a circuit board or a combination of a plurality of circuit boards for implementing the functions described above. In an embodiment of the present application, the circuit board or the combination of the plurality of circuit boards may include: (1) one or more processors; (2) one or more non-transitory computer-readable memories connected to the processor; and (3) firmware that is executable by the processor and stored in the memory.

For example, in other embodiments of the present disclosure, the first processing module 601, the second processing module 602, and/or the third processing module 603 include code(s) and program(s) stored in the memory; the processor(s) may execute the code(s) and program(s) to implement some or all functions of the first processing module 601, the second processing module 602, and/or the third processing module 603 as described above.

The control apparatus for controlling the working frequency of the TOF sensor in the embodiments of the present disclosure have at least the following beneficial effects:

the control apparatus for controlling the working frequency of the TOF sensor achieves dynamic regulation and control of the working frequency of the TOF sensor. If the distance between the TOF sensor and the face region is farther, or if the distance between the TOF sensor and the face region is farther and the deviation ratio is larger, the working frequency of the TOF sensor is increased in real time, thus improving the security of payment; if the distance between the TOF sensor and the face region is closer, or if the distance between the TOF sensor and the face region is closer and the deviation ratio is smaller, the working frequency of the TOF sensor is reduced in real time, thus saving power and reducing power consumption, which significantly improve the user experience.

For contents that is not detailed in the control apparatus for controlling the working frequency of the TOF sensor provided by the embodiments of the present disclosure, reference can be made to the related descriptions of the method for controlling the working frequency of the TOF sensor provided by the above embodiments. The control apparatus for controlling the working frequency of the TOF sensor provided by the embodiments of the present disclosure can achieve the same beneficial effects as those of the method for controlling the working frequency of the TOF sensor provided by the above embodiments, which will not be repeated here.

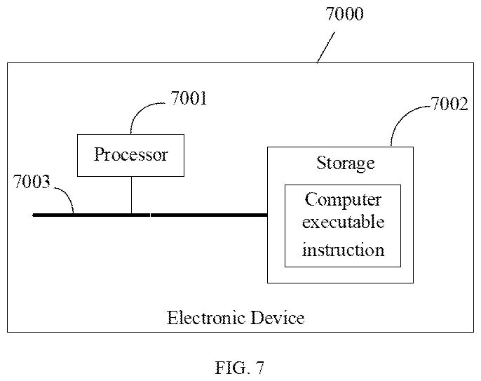

Based on the same inventive concept, the embodiments of the present disclosure also provide an electronic device. The structural schematic diagram of the electronic device is shown in FIG. 7. The electronic device 7000 includes at least one processor 7001, a storage 7002, and a bus 7003, and the at least one processor 7001 is electrically connected with the storage 7002 through the bus 7003. The storage 7002 is configured to store at least one computer executable instruction, and the processor 7001 is configured to execute the at least one computer executable instruction, so as to execute the steps of any one of the method for controlling the working frequency of the TOF sensor provided by any embodiment or any alternative implementation of the present disclosure.

Further, the processor 7001 may be an FPGA (Field-Programmable Gate Array) or other devices with logic processing capability, such as MCU (Microcontroller Unit) and CPU (Central Process Unit).

For example, the storage 7002 may include any combination of one or more computer program products, and the computer program products may include various forms of computer-readable storage media, such as volatile memory and/or non-volatile memory. For example, the volatile memory may include a random access memory (RAM) and/or a cache, and the like. For example, the non-volatile memory may include a read-only memory (ROM), a hard disk, an erasable programmable read-only memory (EPROM), portable compact disk read-only memory (CD-ROM), a USB memory, a flash memory, and the like. One or more computer executable instructions can be stored on the computer-readable storage medium, and the processor 7001 can execute the computer executable instruction(s) to achieve various functions. The computer-readable storage medium can also store various applications and various data, as well as various data used and/or generated by the applications, etc.

The embodiments of the present disclosure have at least the following beneficial effects:

The electronic device achieves dynamic regulation and control of the working frequency of the TOF sensor. If the distance between the TOF sensor and the face region is farther, or if the distance between the TOF sensor and the face region is farther and the deviation ratio is larger, the working frequency of the TOF sensor is increased in real time, thus improving the security of payment; if the distance between the TOF sensor and the face region is closer, or if the distance between the TOF sensor and the face region is closer and the deviation ratio is smaller, the working frequency of the TOF sensor is reduced in real time, thus saving power and reducing power consumption, which significantly improve the user experience.

Based on the same inventive concept, the embodiments of the present disclosure also provide a computer-readable storage medium, computer programs are stored on the computer-readable storage medium, and in a case where the computer programs are executed by a processor, the steps of any one of the methods for controlling the working frequency of the TOF sensor provided by any embodiment or any alternative implementation of the present disclosure are achieved.

The computer-readable storage medium provided by the embodiments of the present disclosure include, but are not limited to, any type of disks (including floppy disk, hard disk, optical disk, CD-ROM, and magneto-optical disk), ROM (Read-Only Memory), RAM (Random Access Memory), EPROM (erasable programmable read-only memory), EEPROM (electrically erasable programmable read-only memory), a flash memory, a magnetic card, or an optical card. That is, the readable storage medium includes any medium that stores or transmits information in a readable form by a device (e.g., a computer).

For example, in some embodiments, the computer-readable storage medium can be applied to the electronic device provided by any of the above embodiments, for example, the computer-readable storage medium can be the storage in the electronic device.

The embodiments of the present disclosure have at least the following beneficial effects:

inputting a target image frame into a preset face detection model for face detection to determine a face region in the target image frame; determining feature information of the face region, according to the face region and depth information of the target image frame acquired by the TOF sensor; regulating and controlling a working frequency of the TOF sensor, according to the feature information and a preset working frequency of the TOF sensor; thus achieving dynamic regulation and control of the working frequency of the TOF sensor. If the distance between the TOF sensor and the face region is farther, or if the distance between the TOF sensor and the face region is farther and the deviation ratio is larger, the working frequency of the TOF sensor is increased in real time, thus improving the security of payment; if the distance between the TOF sensor and the face region is closer, or if the distance between the TOF sensor and the face region is closer and the deviation ratio is smaller, the working frequency of the TOF sensor is reduced in real time, thus saving power and reducing power consumption, which significantly improve user experience.

Those skilled in the art can understand that computer program instructions can be used to implement each block in these structure diagrams and/or block diagrams and/or flow diagrams and combinations of blocks in these structure diagrams and/or block diagrams and/or flow diagrams. Those skilled in the art can understand that these computer program instructions can be provided to general-purpose computers, professional computers, or processors of other programmable data processing methods to implement, so that a computer or a processor of other programmable data processing method can execute the technical schemes specified in a block or a plurality of blocks of the structure diagrams and/or block diagrams and/or flow diagrams disclosed in the present disclosure.

Those skilled in the art can understand that steps, measures, and solutions in various operations, methods, and processes that have been discussed in the present disclosure can be alternated, changed, combined, or deleted. Further, other steps, measures, and solutions in the various operations, methods, and processes that have been discussed in the present disclosure can also be alternated, changed, rearranged, decomposed, combined, or deleted. Further, the steps, measures, and solutions in the various operations, methods, and processes that have been disclosed in the present disclosure in the prior art can also be alternated, changed, rearranged, decomposed, combined or deleted.

What have been described above are only part of the implementations of the present disclosure, it should be pointed out that for those of ordinary skill in the art, without departing from the principles of the present disclosure, several improvements and modifications can be made, and these improvements and modifications should also be regarded as the protection scope of the present disclosure.

1. A method for controlling a working frequency of a time of flight (TOF) sensor, comprising:
inputting a target image frame into a preset face detection model for face detection to determine a face region in the target image frame;
determining feature information of the face region, according to the face region and depth information of the target image frame acquired by the TOF sensor; and
regulating and controlling the working frequency of the TOF sensor, according to the feature information and a preset working frequency of the TOF sensor.

2. The method according to claim 1, wherein the determining the feature information of the face region, according to the face region and the depth information of the target image frame acquired by the TOF sensor comprises:
determining local depth information corresponding to respective parts of the face region, according to the face region and the depth information of the target image frame acquired by the TOF sensor;
determining an average depth value of the face region, according to the face region and the local depth information, wherein the feature information comprises the average depth value.

3. The method according to claim 2, wherein the determining the feature information of the face region, according to the face region and the depth information of the target image frame acquired by the TOF sensor further comprises:
determining a deviation ratio between a center point of the face region and a center point of the target image frame, according to the target image frame and the face region, wherein the feature information further comprises the deviation ratio.

4. The method according to claim 1, wherein before the inputting the target image frame into the preset face detection model for face detection, the method further comprises: acquiring a plurality of image frames to be processed, and acquiring and determining depth information of the plurality of image frames to be processed through the TOF sensor; and
the inputting the target image frame into the preset face detection model for face detection to determine the face region in the target image frame, comprises:
inputting any image frame to be processed among the plurality of image frames to be processed into the preset face detection model for face detection, and if a face is detected, taking the any image frame to be processed as the target image frame, and determining the face region in the target image frame.

5. The method according to claim 2, wherein the determining the local depth information corresponding to respective parts of the face region, according to the face region and the depth information of the target image frame acquired by the TOF sensor, comprises:
determining the local depth information corresponding to respective parts of the face region, according to a feature parameter of the face region and the depth information of the target image frame.

6. The method according to claim 3, wherein the determining the deviation ratio between the center point of the face region and the center point of the target image frame, according to the target image frame and the face region, comprises:
determining the deviation ratio, according to a feature parameter of the face region and a feature parameter of the target image frame.

7. The method according to claim 6, wherein the feature parameter of the face region comprises a first start value of the face region corresponding to a first direction, a second start value of the face region corresponding to a second direction, a first width parameter of the face region corresponding to the first direction, a first height parameter of the face region corresponding to the second direction; or, the feature parameter of the face region comprises a first start value and a first end value of the face region corresponding to a first direction, and a second start value and a second end value of the face region corresponding to a second direction;
the feature parameter of the target image frame comprises a third start value of the target image frame corresponding to the first direction, a fourth start value of the target image frame corresponding to the second direction, a second width parameter of the target image frame corresponding to the first direction, a second height parameter of the target image frame corresponding to the second direction; or, the feature parameter of the target image frame comprises a third start value and a third end value of the target image frame corresponding to the first direction, and a fourth start value and a fourth end value of the target image frame corresponding to the second direction;
wherein the face region is in a face region plane coordinate system, the first direction of the face region is parallel to a horizontal axis direction of the face region plane coordinate system, and the second direction of the face region is parallel to a longitudinal axis direction of the face region plane coordinate system.

8. The method according to claim 7, wherein the determining the average depth value of the face region, according to the face region and the local depth information, comprises:
summing the local depth information to determine a first parameter;
determining a second parameter, according to a product of the first width parameter and the first height parameter, or determining a second parameter, according to a product of an absolute value of a difference between the first end value and the first start value and an absolute value of a difference between the second end value and the second start value; and
dividing the first parameter by the second parameter to determine the average depth value.

9. The method according to claim 8, wherein the regulating and controlling the working frequency of the TOF sensor, according to the feature information and the preset working frequency of the TOF sensor, comprises:
regulating and controlling the working frequency of the TOF sensor, according to the average depth value and the preset working frequency of the TOF sensor.

10. The method according to claim 9, wherein the regulating and controlling the working frequency of the TOF sensor, according to the average depth value and the preset working frequency of the TOF sensor, comprises:
determining a third parameter, according to a product of the average depth value and the preset working frequency;
summing the first width parameter of the face region and the first height parameter of the face region to determine a fourth parameter, or summing an absolute value of a difference between the first end value and the first start value and an absolute value of a difference between the second end value and the second start value to determine a fourth parameter; and
dividing the third parameter by the fourth parameter to determine an updated working frequency of the TOF sensor, wherein the updated working frequency is less than an upper threshold of the working frequency of the TOF sensor.

11. The method according to claim 7, wherein
the determining the deviation ratio, according to the feature parameter of the face region and the feature parameter of the target image frame, comprises:
determining a first center point parameter of the center point of the face region, according to the first width parameter and the first start value, or determining a first center point parameter of the center point of the face region, according to the first end value and the first start value;
determining a second center point parameter of the center point of the face region, according to the first height parameter and the second start value, or determining a second center point parameter of the center point of the face region, according to the second end value and the second start value;
determining a third center point parameter of the center point of the target image frame, according to the second width parameter and the third start value, or determining a third center point parameter of the center point of the target image frame, according to the third end value and the third start value;
determining a fourth center point parameter of the center point of the target image frame, according to the second height parameter and the fourth start value, or determining a fourth center point parameter of the center point of the target image frame, according to the fourth end value and the fourth start value;
determining a fifth parameter, according to the first center point parameter, the third center point parameter, the second center point parameter, and the fourth center point parameter, wherein the fifth parameter represents a distance between the center point of the face region and the center point of the target image frame;
determining a sixth parameter, according to the second width parameter and the second height parameter, or determining a sixth parameter, according to the third end value, the third start value, the fourth end value, and the fourth start value, wherein the sixth parameter represents half of a diagonal length of the target image frame; and
dividing the fifth parameter by the sixth parameter to determine the deviation ratio.

12. The method according to claim 11, wherein the regulating and controlling the working frequency of the TOF sensor, according to the feature information and the preset working frequency of the TOF sensor, comprises:
regulating and controlling the working frequency of the TOF sensor, according to the average depth value, the deviation ratio, and the preset working frequency of the TOF sensor.

13. The method according to claim 12, wherein
the regulating and controlling the working frequency of the TOF sensor, according to the average depth value, the deviation ratio, and the preset working frequency of the TOF sensor, comprises:
determining a third parameter, according to a product of the average depth value and the preset working frequency;
summing the first width parameter of the face region and the first height parameter of the face region to determine a fourth parameter, or summing an absolute value of a difference between the first end value and the first start value and an absolute value of a difference between the second end value and the second start value to determine a fourth parameter;
determining a seventh parameter, according to a product of the deviation ratio and the preset working frequency;
dividing the third parameter by the fourth parameter to determine an eighth parameter; and
summing the seventh parameter and the eighth parameter to determine an updated working frequency of the TOF sensor, wherein the updated working frequency is less than an upper threshold of the working frequency of the TOF sensor.

14. The method according to claim 1, wherein before the determining the feature information of the face region, according to the face region and the depth information, which is acquired, of the target image frame, the method further comprises:
judging whether a preset application is a payment type application according to an identity of the preset application, wherein the preset application is configured to control an image acquisition device to acquire the target image frame;
where the preset application is a payment type application, performing a step of determining the feature information of the face region, according to the face region and the depth information, which is acquired, of the target image frame, and
where the preset application is not a payment type application, not regulating and controlling the working frequency of the TOF sensor.

15. A control apparatus for controlling a working frequency of a TOF sensor, comprising:
a first processing module, configured for inputting a target image frame into a preset face detection model for face detection to determine a face region in the target image frame;
a second processing module, configured for determining feature information of the face region, according to the face region and depth information of the target image frame acquired by the TOF sensor; and
a third processing module, configured for regulating and controlling the working frequency of the TOF sensor, according to the feature information and a preset working frequency of the TOF sensor.

16. The control apparatus according to claim 15, wherein the feature information comprises an average depth value of the face region,
the second processing module is configured for determining local depth information corresponding to respective parts of the face region, according to the face region and the depth information of the target image frame acquired by the TOF sensor; determining the average depth value, according to the face region and the local depth information;
the third processing module is configured for regulating and controlling the working frequency of the TOF sensor, according to the average depth value and the preset working frequency of the TOF sensor.

17. The control apparatus according to claim 15, wherein the feature information comprises an average depth value of the face region, and a deviation ratio between a center point of the face region and a center point of the target image frame,
the second processing module is configured for determining local depth information corresponding to respective parts of the face region, according to the face region and the depth information of the target image frame acquired by the TOF sensor; determining the average depth value, according to the face region and the local depth information; and determining the deviation ratio, according to the target image frame and the face region;
the third processing module is configured for regulating and controlling the working frequency of the TOF sensor, according to the deviation ratio, the average depth value, and the preset working frequency of the TOF sensor.

18. An electronic device, comprising: a processor and a storage;
wherein the storage is configured for storing computer programs; and
the processor is configured for performing the method for controlling the working frequency of the TOF sensor according to claim 1 by calling and running the computer programs.

19. A computer-readable storage medium, wherein the computer-readable storage medium stores computer programs, when the computer programs are executed by a processor, the method for controlling the working frequency of the TOF sensor according to claim 1 is achieved.

20. The method according to claim 2, wherein before the determining the feature information of the face region, according to the face region and the depth information, which is acquired, of the target image frame, the method further comprises:
judging whether a preset application is a payment type application according to an identity of the preset application, wherein the preset application is configured to control an image acquisition device to acquire the target image frame;
where the preset application is a payment type application, performing a step of determining the feature information of the face region, according to the face region and the depth information, which is acquired, of the target image frame, and
where the preset application is not a payment type application, not regulating and controlling the working frequency of the TOF sensor.
